(19) United States
(12) Patent Application Publication
(10) Pub. No.: US 2009/0037375 A1
(43) Pub. Date: Feb. 5, 2009

(54) METHOD AND APPARATUS FOR THE PLACEMENT OF ADVERTISEMENTS IN A SEARCH RESULTS PAGE

(76) Inventor: Seok Won Cho, San Clemente, CA (US)

Correspondence Address: YAHOO! INC.;C/O DREIER LLP, 499 PARK AVENUE, NEW YORK, NY, 10022, US

(21) Appl. No.: 11/830,282

(22) Filed: Jul. 30, 2007

(51) Int. Cl. G06F 17/30

(52) U.S. Cl. 707/3; 707/E17.014

(57) ABSTRACT

Optimizing search advertising on a search results page in response to a search request includes the search engine determining advertisements for inclusion with the search results, where the advertisements include different advertisement techniques. The method includes selecting one or more of the advertisements for inclusion with the search results page, which may be from different advertising techniques. Additionally, the selection of the advertisements may be based on user click activity, advertisement performance data and the plurality of advertisements, where the advertisements are associated with the different techniques. Thereupon, search result page includes selected advertisements optimized for the benefit of the sponsor and page revenue.

### RELATED APPLICATION

The present application is related to co-pending patent application Ser. No. ______, entitled “METHOD AND APPARATUS FOR UTILIZING SEARCH RESULT ADVERTISEMENT INVENTORY,” filed on ______, 2007.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to advertising techniques relative to computer-based search engine results and more specifically to optimize the selection and/or placement of one or more advertisements relative to various available advertising techniques on an electronic search results page.

### BACKGROUND OF THE INVENTION

It is commonplace to use search engines in almost all levels of modern computing. Most widely known techniques are web-based techniques for searching on Internet-based web sites. Equally common with a search request and a search results page, is finding advertisements in various locations on the search results page.

There are many existing and well-known techniques for advertising on web pages. Each of these advertising techniques includes known protocols and algorithms for the placement of the advertisements on the particular search result pages including based on the relevance to search term(s). Although, the problem is that each of these advertising techniques focus solely and exclusively on optimizing each individual technique and fail to include or otherwise take into account the other advertising techniques that may be incorporated on the search results page.

With web-based search advertising, it is not uncommon for an advertiser, the person or entity who pays for the advertisement to purchase or have advertising contracts that include advertisements with more than one advertising technique. Therefore, under existing search engines that place advertising on search result pages, it is possible to cannibalize the advertiser's budget by overlapping advertising techniques. For example, the advertiser might pay for numerous ads placed in different locations on the same search results page, which can be ineffective or the sponsor and the search engine provider trying to maximize revenue per page.

Additionally, existing systems fail to take into account user click activity when selecting advertising techniques. Current technology allows for the tracking of user click activity, but this information is not made available when selecting the placement of advertisements on a search results page. Rather, the system uses standard algorithms that select appropriate advertisements for each of the different advertisement techniques found on the page and then assembles the page with the advertisements for the user.

As such, there exists a need for a technique to generate search results that optimizes a selection of an advertisement technique when selecting advertisements for a search results page and also takes into account user click activity in the selection or placement process.

### SUMMARY OF THE INVENTION

Generally, the present invention provides for optimizing search advertising on a search results page. In response to a search request, the search engine determines different advertisements that may be included with the search results to be displayed on the search results page. The ads include different specific advertisements, for example for different sponsors, and also includes different advertisement techniques, such as for the same or different sponsors. As used herein, advertisement techniques refer to the type of advertisement and the underlying model for the advertising activity, such as how the sponsor pays for the advertising for example on a per-click basis, per-view basis, etc. Examples of advertising techniques may include, but are not specifically limited to the following techniques: the cost per click sponsored search (CPC), cost per media product (CPM), cost per period product (CPP) and cost per acquisition product (CPA).

The present invention thereupon selects one or more of the advertisements for the different advertising techniques for inclusion with the search results page. The selected advertisements may be from different advertising techniques suitable for the search results page. Additionally, the selection of the advertisements may be based on user click activity, advertisement performance data and the plurality of advertisements, where the advertisements are associated with the different techniques. For example, advertisements by a particular sponsor may be determined as being appropriate for the search results page, but the present invention may select an advertisement from a first technique over a second technique to optimize the effectiveness of the advertisement. In the same example, sponsor advertisements may be selected for a particular advertising technique instead of being includes in numerous advertising techniques on the same search results page, to maximize the advertisement exposure.

Thereupon, the present invention includes the generation of the search result page having the selected advertisements thereon. These advertisements may be embedded or included based on the corresponding advertising technique, such as being in a conspicuous location on the search results page, included in the search result listings, or other techniques, by way of example. The advertisements included in the search results page are thereby optimized for the benefit of the sponsor and the search engine provider.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of an apparatus for optimizing advertising revenue on a search results page;

FIG. 2 illustrates a computing system utilizing the optimization of advertising revenue for a search results page;

FIG. 3 illustrates a block diagram of one embodiment of elements for optimizing advertising revenue;

FIG. 4 illustrates a sample screen shot including numerous advertising techniques; and

FIG. 5 illustrates a flowchart of the steps of one embodiment of a method for optimizing advertising revenue on a search results page.

### DETAILED DESCRIPTION OF THE INVENTION

In the following description of the embodiments of the invention, reference is made to the accompanying drawings that form a part hereof, and in which is shown by way of illustration exemplary embodiments in which the invention may be practiced. It is to be understood that other embodiments may be utilized and structural changes may be made without departing from the scope of the present invention.

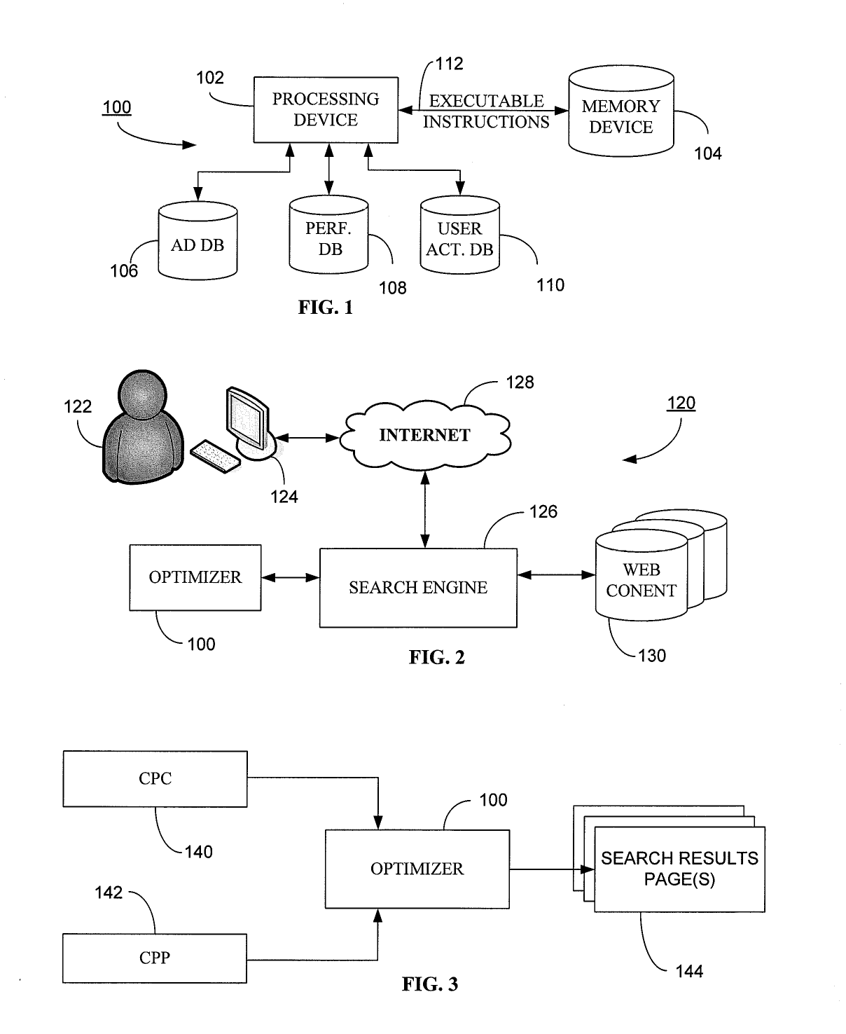

FIG. 1 illustrates an advertisement selection device 100 providing for the optimization of advertising on a search results page by determining the optimized placement of advertisements using proper advertisement techniques. The device 100 is illustrated generally in nature, but as described in further detail below, may be operational within a larger search engine processing system or device.

The device 100 includes a processing device 102, memory device 104 and three databases: an advertisement inventory database 106, a performance database 108 and a user activity database 110. The processing device 102 may be any suitable type of device capable of electronically performing computational operations in response to executable instructions, where the processing device 102 may include one or more processing device or elements in a centralized or distributed processing manner. The memory device 104 and databases 106, 108 and 110 may be any suitable type of data storage device, including one or more storage devices in a centralized or distributed storage manner. The memory device 104 includes executable instructions 112 stored therein readable by the processing device 102 for performing operations, as described in further detailed herein.

The advertisement inventory database 106 includes information on the inventory of advertisements. In one embodiment, the advertisement information may include text or figures to be included in the advertisement. The advertisement inventory information may also indicate the advertising sponsor, the associated advertising technique and costs associated with the particular advertisement itself and/or the advertising technique. Additionally, the database 106 may include information associating advertisements and/or techniques with one or more particular search terms.

The performance database 108 includes performance data relating to the performance or effectiveness of an advertising technique and/or advertisement itself. The performance data stored in the database 108 may indicate that one technique generates more revenue compared with others, for example, or in another example may be more relevant but not generating as much revenue.

The user activity database 110 includes data for user click activity. This user click activity data may be specific to a registered user, such as registered through a cookie or other type of identification instrument. This data may be acquired through tracking the user selection activity using any number of suitable known user activity tracking and selection techniques. Additionally, this data may be more generalized and not directed to a specific user, such as general user click activity tracked over a large sample of users.

The processing device 102, using techniques as described in further detail below, is operative to utilize the advertisement inventory data, the associated performance data and the user click data to define the optimal selection and display of advertisements to minimize revenue cannibalization between different advertisements in advertisement techniques and maximize overall page revenue.

FIG. 2 illustrates a system 120 using the device 100 of FIG. 1, herein referred to as the optimizer 100. In the system 102, a user 122, using a computing device 124, accesses a search engine 126 through the Internet 128. The search engine 126 is in communication with web content databases 130 and the optimizer 100.

The search engine 126 may be any suitable type of search engine, such as a search engine portal referenced by the user 122 through a URL. The search engine 126 may encompass one or more processing devices capable of receiving search requests having search terms and accessing the web content databases 130 that provide hyperlinks or other types of search results. In accordance with known search engine technology, the search engine 126 not only performs the search, but also is operative to generate a search results page. Although, the search engine 126 further includes optimized advertising in the search results page via the optimizer 100.

It is recognized that additional known features and elements have been omitted, for clarity purposes only, between the computing device 124 and the search engine 126, such as communication and routing elements for interacting across the Internet 128. It is also recognized that the network 128, while illustrated as the Internet, may be any suitable type of network, such as an internal, local or private network, by way of example.

In one embodiment, the user 122 sends a search request to the search engine 126. The search engine 126 may perform known content searching operations by accessing the web content databases 130. Although, in generating a search results page, the search engine 126 also accesses the optimizer 100.

In one embodiment, the optimizer 100 uses a page module, where the page refers to the search results page provided to the user 122. A page module is defined as distinct groups of listing for content for a given keyword, where the content may be paid content or algorithmic content.

Each page module includes three (3) properties, a revenue per search module (mRPS), a relevance index module (mRI) and a confidence index (mCI). The revenue per search (mRPS) module is set to zero for non-monetization products. The relevance index module (mRI) is equal to a click through rate module (mCTR). The confidence index (mCI) module is equal to a distribution of a historical module fingerprint (mFP) and a current module finger print, (d[historical mFP, current mFP]).

The modules may also be different based on the advertising techniques, such as the exemplary techniques of: CPC, CPM, CPP, and/or CPA.

In one embodiment, the module revenue per search may be defined by Equation 1 for CPC products and by Equation 2 for non-CPC products, such as CPM and CPP advertising techniques.

mRPS=mCTR*mCOV*mCPC EQUATION 1:

mRPS=mCOV*CPS*mDEPTH EQUATION 2:

The mCTR factor is the module click through rate, whereby in one embodiment historical performance can be used as a future performance indicator or estimator. For example, different indexed periods may be used, wherein the shorter the interval, the more accuracy can be obtained in the optimization calculations.

The mCOV value refers to a Coverage module, which is a known value currently available from existing systems, which is either a “0” or a “1” value. The module cost per click (mCPC) is an existing value that can be obtained from the existing search inventory system, wherein the cost per click may be set equivalent to the cost per click of a first or prior result. The CPS value refers to a cost per search amount.

The fingerprint module (mFP) includes an indexed historical fingerprint for each keyword and if the fingerprint changes, the system discounts accordingly in a linear fashion based on the current module fingerprint distance from the click through rate module.

In one embodiment, the above-noted modules utilize values that can be calculated in an offline fashion for indexing and storing historical performance indices. The module values themselves may then be computing at run-time.

The optimizer 100 may thereupon optimize ad revenue by adjusting revenue and relevance values, or dials. These adjustable values relate to revenue and relevance for advertisements. In one embodiment, the values are adjusted between a minimum value, e.g. zero, and a maximum value, e.g. one, where the maximum value indicates the highest revenue and/or relevance. The mRPS and MRI values have their own relative marketplace bounded by the modules that have such property on the search results page. In one embodiment, the mRPS and mRI do not directly or inversely correlate in a linear fashion and can be linearly independent.

In one embodiment, the optimizer 100 may take a conservative approach and denote modules that have a greater fingerprint distance from historical indexed values. In essence, for each module on the search results page, the system may calculate a score using a rank score module (mRS), as defined by Equation 3.

mRS=mCI((mRPS*pREVENUE)+(mRI*pRELEVANCE)) EQUATION 3:

where the pREVENUE and pRELEVANCE values may be adjusted between the minimum values and the maximum values.

The optimizer 100 thereupon ranks the modules based on the relative mRS values for each module. This information may then be used to determine which advertisements are selected and their corresponding advertising techniques. The selected advertisements are then presented to the search engine 126 for inclusion and rendering in the search results page to the user 122.

The optimizer 100 optimizes the revenue of the advertisements while maintaining the proper relevance. The system 100 may be akin to a balance, whereby the system must balance the ad revenue with the search result relevance. These elements do bare a larger relationship as irrelevant advertising techniques or advertising content can directly influence revenue. But as described above, to optimize revenue and prevent against cannibalizing revenue availability between different advertising techniques, the optimization may take into account competing advertisements in competing or complimentary advertisement techniques on the search results page. Stated another way, revenue may be optimized by placing one sponsor's advertisements at all locations on a search results page, but this diminishes relevance because the sponsor is paying for a significant percentage of ads that may not be viewed or selected. Thereby, to optimize revenue for the search results page as well as the relevance of the advertisement, one or more particular advertisements and corresponding advertisement techniques are appropriately selected.

FIG. 3 is a sample illustration of one embodiment of the application of the method for optimized advertising revenue. The system illustrates two sample advertising techniques that have associated advertisements. The first technique is the cost per click sponsored search 140 and the second is a cost per period product 142. These two sample advertising techniques and corresponding advertisements have different relevance and revenue factors based on the associated search results.

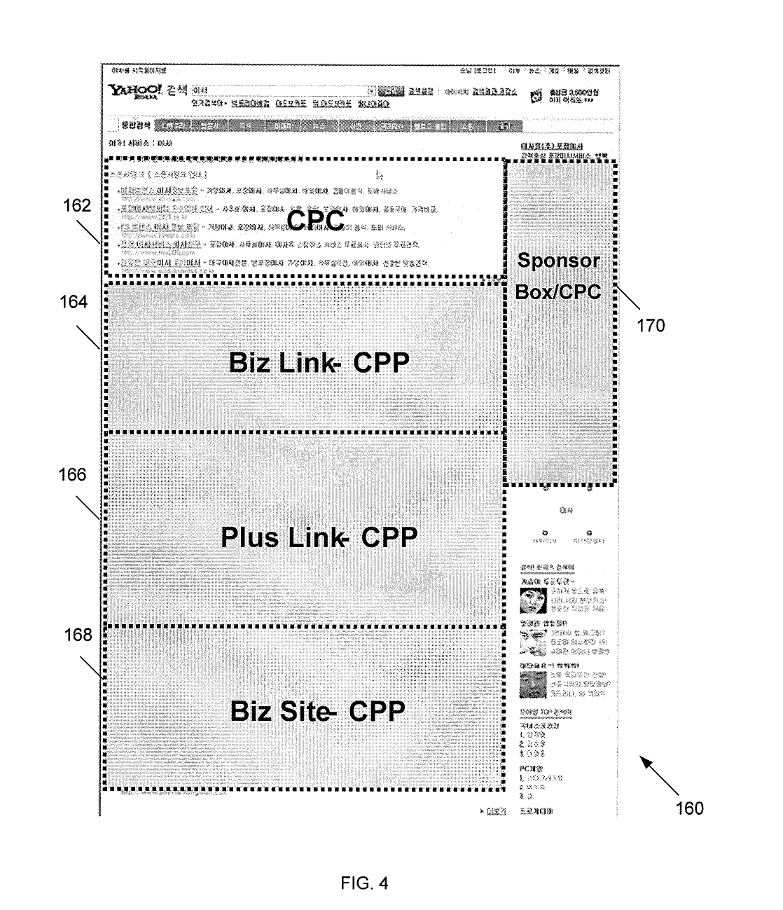

In response to a search request and search results, the ad revenue optimizer 100 receives, or in another embodiment retrieves, advertisements from the different advertising techniques. In a typical embodiment, the advertising techniques may be associated with a predefined section or area of a search results page, as discussed in further detail below regarding FIG. 4. The optimizer 100 thereupon provides the selected advertisements for insertion or inclusion into the search results page(s) 144 associated with the particular search result techniques.

FIG. 4 illustrates a sample screen shot 160 of a search results page with separate advertising techniques thereon. This exemplary search result page includes a CPC section 162, a business link CPP section 164, a plus link CPP section 166, a business site CPP 168 section and a sponsor box/CPC section 170. This sample screen shot illustrates how many numerous advertising techniques may be simultaneously displayed. The sample screen shot, as generated in accordance with the method and apparatus described herein, includes the optimized selected advertisements for each of the different sections in this search results page.

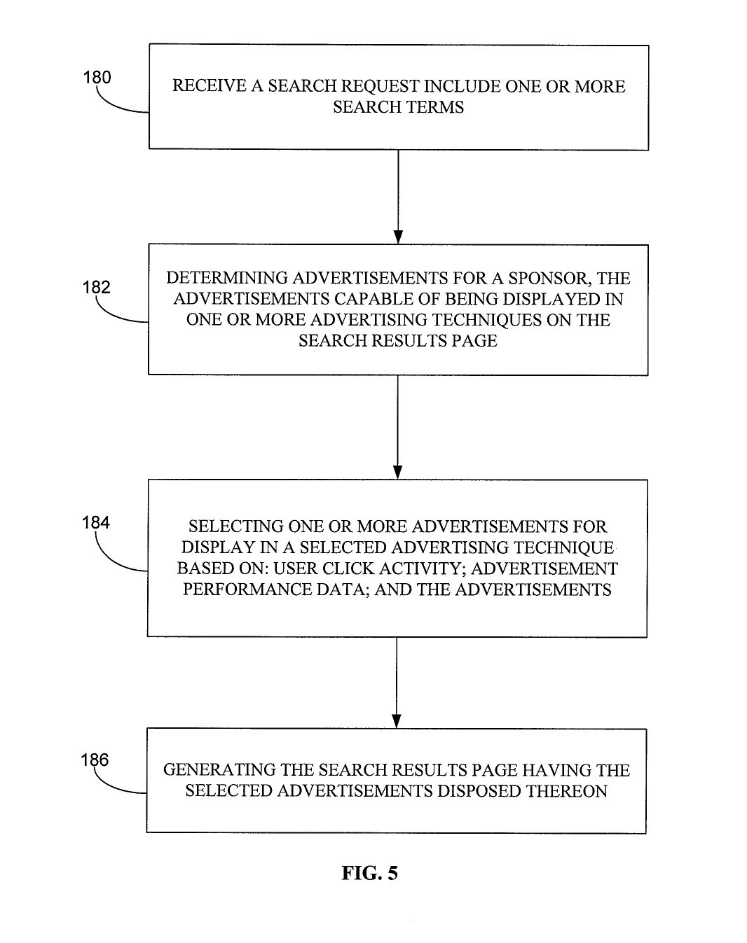

FIG. 5 illustrates a flowchart of one embodiment of a method for optimizing advertisement on a search results page. The method includes, step 180, receiving a search result that includes one or more search terms. As noted above, the search request may be received from the user 120 in FIG. 2.

The next step, step 182, is determining advertisements for a sponsor, where the advertisements are capable of being displayed in one or more advertising techniques on a search results page. This step may be performed by accessing an advertisement database that includes the advertisement and advertisement technique information. For example, a particular sponsor may have numerous advertisements that can be included in different advertisement techniques, or may have advertisements that are directed to specific techniques.

The next step, step 184, is selecting one or more advertisements for display in a selected advertising technique based on user click activity, advertisement performance data and the advertisements. In one embodiment, as described above, databases 106, 108 and 110 may include this information stored therein prior to the search request in step 180. The selection of step 184 may be performed in accordance with the above-described operations of FIGS. 1-3.

Therefore, upon selection, a next step, step 186, is generating the search results page having the selected advertisements disposed therein. This search results page may be generated by the search engine, such as the engine 126 of FIG. 2, whereby the search results page has the optimized selection of advertisements and advertising technique. By further way of example, the search results page may be similar to the exemplary search results page 160 of FIG. 4.

Thereby, the above-described device and its operations performance in response to executable instructions provides for the optimized selection and placement of advertisements in a search results page to prevent cannibalization between advertisement techniques and maximize overall advertisement page revenue.

FIGS. 1-5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms memory and/or storage device may be used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for optimizing advertising on a search results page, the method comprising:
receiving a search request having at least one search term;
determining a plurality of advertisements for a sponsor capable of being displayed in a plurality of advertising techniques on the search results page;
selecting at least one of the plurality of advertisements to be displayed in a selected advertising technique based on user click activity, advertisement performance data and the plurality of advertisements; and
generating the search results page having the selected advertisements disposed thereon.

2. The method of claim 1, wherein the selection of advertisements includes selecting between advertisements associated with the advertising techniques.

3. The method of claim 1, wherein the advertising techniques include a cost per click technique, a cost per media technique, a cost per period technique and a cost per acquisition technique.

4. The method of claim 3, wherein the advertising techniques include associated ad revenue models such that the selection of the at least one of the plurality of advertisements is based on the ad revenue models of the advertising techniques associated with the plurality of advertisements.

5. The method of claim 1 further comprising:
in response to the search request having the at least one search term, retrieving search result terms from at least one search database; and
selecting the plurality of advertisements from an advertisement database based on at least one of the at least one search term.

6. The method of claim 1, wherein the search results page includes the selected advertisements disposed at different advertising locations on the search results page, in accordance with corresponding advertising techniques.

7. Computer readable media comprising program code that when executed by a programmable processor causes the processor to execute a method for optimizing advertising on a search results page, the computer readable media comprising:
program code for receiving a search request having at least one search term;
program code for determining a plurality of advertisements for a sponsor capable of being displayed in a plurality of advertising techniques on the search results page;
program code for selecting at least one of the plurality of advertisements to be displayed in a selected advertising technique based on user click activity, advertisement performance data and the plurality of advertisements; and
program code for generating the search results page having the selected advertisements disposed thereon.

8. The computer readable media of claim 7, wherein program code for selecting advertisements includes selecting between advertisements associated with the advertising techniques.

9. The computer readable media of claim 7, wherein program code for advertising techniques include a cost per click technique, a cost per media technique, a cost per period technique and a cost per acquisition technique.

10. The computer readable media of claim 9, wherein the program code for advertising techniques includes associated ad revenue models such that the selection of the at least one of the plurality of advertisements is based on the ad revenue models of the advertising techniques associated with the plurality of advertisements.

11. The computer readable media of claim 7 further comprising:
in response to the search request having the at least one search term, program code for retrieving search result terms from at least one search database; and
program code for selecting the plurality of advertisements from an advertisement database based on at least one of the at least one search term.

12. The computer readable media of claim 7, wherein the program code for generating the search results page the selected advertisements disposed at different advertising locations on the search results page, in accordance with corresponding advertising techniques.

13. An apparatus for optimizing advertising on a search results page, the apparatus comprising:
a memory device having executable instructions stored therein; and
a processing device, in response to the executable instructions, operative to:
receive a search request having at least one search term;
determine a plurality of advertisements for a sponsor capable of being displayed in a plurality of advertising techniques on the search results page;
select at least one of the plurality of advertisements to be displayed in a selected advertising technique based on user click activity, advertisement performance data and the plurality of advertisements; and
generate the search results page having the selected advertisements disposed thereon.

14. The apparatus of claim 13, wherein the selection of advertisements includes selecting between advertisements associated with the advertising techniques.

15. The apparatus of claim 13, wherein the advertising techniques include a cost per click technique, a cost per media technique, a cost per period technique and a cost per acquisition technique.

16. The apparatus of claim 15, wherein the advertising techniques include associated ad revenue models such that the selection of the at least one of the plurality of advertisements is based on the ad revenue models of the advertising techniques associated with the plurality of advertisements.

17. The apparatus of claim 13, the processing device in response to the executable instructions, further operative to:
in response to the search request having the at least one search term, retrieve search result terms from at least one search database; and
select the plurality of advertisements from an advertisement database based on at least one of the at least one search term.

18. The apparatus of claim 13, wherein the search results page includes the selected advertisements disposed at different advertising locations on the search results page, in accordance with corresponding advertising techniques.
